(19) United States
(12) Patent Application Publication
(10) Pub. No.: US 2020/0367263 A1
(43) Pub. Date: Nov. 19, 2020

(54) MEDIUM ACCESS CONTROL LAYER TRANSMISSION OPPORTUNITY PREEMPTION FOR WI-FI

(71) Applicant: Intel Corporation, Santa Clara, CA (US)

(72) Inventors: Dave Cavalcanti, Portland, OR (US); Laurent Cariou, Portland, OR (US); Javier Perez-Ramirez, North Plains, OR (US); Juan Fang, Portland, OR (US); Mikhail Galeev, Beaverton, OR (US)

(21) Appl. No.: 16/945,424

(22) Filed: Jul. 31, 2020

Related U.S. Application Data
(60) Provisional application No. 62/881,593, filed on Aug. 1, 2019.

(51) Int. Cl. H04W 72/12; H04W 28/06; H04L 27/26

(52) U.S. Cl. CPC H04W 72/12; H04W 84/12; H04L 27/2605; H04W 28/06

(57) ABSTRACT

This disclosure describes systems, methods, and devices related to medium access control (MAC) layer preemptable transmission opportunities. A device may identify a MAC layer frame to be transmitted during a transmission opportunity. The device may determine that the MAC layer frame is a preemption frame. The device may identify a preemptable frame to be transmitted during the transmission opportunity. The device may send the preemption frame during the transmission opportunity, and may send the preemptable frame after the transmission opportunity has concluded, wherein to send the preemptable frame includes preempting transmission of the preemptable frame during the transmission opportunity based on the determination that the MAC layer frame is a preemption frame.

### CROSS-REFERENCE TO RELATED APPLICATIONS

This application is related to and claims priority to U.S. Provisional Patent Application No. 62/881,593, filed Aug. 1, 2019, which is hereby incorporated herein by reference in its entirety.

### TECHNICAL FIELD

This disclosure generally relates to systems and methods for wireless communications and, more particularly, to preemptable transmission opportunities.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for preemptable transmission opportunities, in accordance with one or more example embodiments of the present disclosure.

FIG. 2A depicts an example time-sensitive transmission process, in accordance with one or more example embodiments of the present disclosure.

FIG. 2B depicts an example time-sensitive transmission process, in accordance with one or more example embodiments of the present disclosure.

FIG. 2C depicts an example time-sensitive transmission process, in accordance with one or more example embodiments of the present disclosure.

FIG. 2D depicts an example time-sensitive transmission process, in accordance with one or more example embodiments of the present disclosure.

FIG. 2E depicts an example time-sensitive transmission process, in accordance with one or more example embodiments of the present disclosure.

FIG. 2F depicts an example time-sensitive transmission process, in accordance with one or more example embodiments of the present disclosure.

FIG. 3 depicts an example schematic of an enhanced communication layer stack of a device used for transmission preemption, in accordance with one or more example embodiments of the present disclosure.

FIG. 4A illustrates a flow diagram of illustrative process for a medium access control (MAC) layer transmission opportunity (TXOP) preemption, in accordance with one or more example embodiments of the present disclosure.

FIG. 4B illustrates a flow diagram of illustrative process for a medium access control (MAC) layer transmission opportunity (TXOP) preemption, in accordance with one or more example embodiments of the present disclosure.

FIG. 5 illustrates a functional diagram of an exemplary communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

FIG. 7 is a block diagram of a radio architecture in accordance with some examples.

FIG. 8 illustrates an example front-end module circuitry for use in the radio architecture of FIG. 7, in accordance with one or more example embodiments of the present disclosure.

FIG. 9 illustrates an example radio IC circuitry for use in the radio architecture of FIG. 7, in accordance with one or more example embodiments of the present disclosure.

FIG. 10 illustrates an example baseband processing circuitry for use in the radio architecture of FIG. 7, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

People increasingly are using devices for wireless communications. Some applications that use wireless communications may be time-sensitive, requiring minimal latency and jitter. For example, time-sensitive network (TSN) applications may include audio-visual applications, industrial applications, automotive applications, and other applications. TSNs may be managed (e.g., protected domains) for which admission control is required. In particular, access points (APs) may be controlled by a single entity (e.g., a coordinator AP). TSN sensitivity may refer to time synchronization requirements of 1 microsecond or better, low latency, and minimal packet loss. For example, an industrial TSN use such as robots and controllers may be undermined due to latency, jitter, and packet loss. Real-time gaming may be undermined due to the same issues. Packets not delivered on time due to such issues may be considered lost, undermining TSN operations.

Some of the main problems in the IEEE 802.11 technical standards that define medium access control (MAC) layer functionality to support time-sensitive applications include latency and jitter that may be caused by a long data transmission of a time sensitive data frame (e.g., a MAC service data unit—MSDU) arriving at an IEEE 802.11-defined MAC layer of a device. For example, when a device is to transmit or receive a time-sensitive frame just before or during a long transmission (e.g., of a video frame), the device may wait for the long transmission to be completed before the time-sensitive frame is transmitted or processed, thereby causing the time-sensitive frame to miss a delivery deadline. For time-sensitive applications, such latency may pose a problem for device operations and/or user experience. Latency and jitter problems are being addressed for inclusion in the next generation IEEE 802.11be technical standard.

Some IEEE 802.11 time-sensitive networking (TSN) standards are being developed to enable time synchronization, guarantee latency and high reliability (primarily over wired/Ethernet links) through bandwidth reservation, time-aware scheduling, and redundancy. For example, some time synchronization is defined by the IEEE 802.11 technical standards (e.g., timing measurements and fine timing measurements). Frame-preemption is another TSN capability that is defined by the IEEE 802.11 standards, but only for Ethernet, and supported by the IEEE 802.3br Ethernet MAC enhancements (e.g., Ethernet technical standard). Frame preemption is yet to be extended to the IEEE 802.11 technical standards for Wi-Fi. Frame preemption may refer to a device's ability to interrupt transmission of preemptable frames to allow for transmission of a different frame. For example, as a device transmits a best-effort frame, the device may interrupt the transmission of the best-effort frame (e.g., resulting in partial transmission) to transmit higher-priority traffic. The interrupted transmission may resume after transmission of the higher-priority traffic.

There are multiple possible approaches to introduce frame-preemption capabilities to Wi-Fi communications. One approach may use physical layer (PHY)-based protocol data unit (PPDU)-level preemption. PPDU-level preemption may require PHY modifications and solutions for both downlink and uplink PPDU preemption, and may provide reduced overhead (e.g., increased efficiency), but at the cost of higher complexity. Another approach may use MAC-based transmission opportunity (TXOP)-level preemption. MAC-based TXOP-level preemption may occur at the MAC layer, and no PHY modifications may be required. This approach may have slightly higher overhead, but it may be simpler to implement than PHYpreemption. However, no MAC layer solution exists to facilitate frame preemption in 802.11 for Wi-Fi.

Example embodiments of the present disclosure relate to systems, methods, and devices for MAC enhancements to enable preemptable transmission opportunities and express service for time-sensitive data in 802.11be.

In one or more embodiments, when a device occupies a communication channel for a wireless transmission (e.g., a best-effort transmission), the device may switch from the best-effort transmission to a TSN transmission at the PPDU level during a TXOP reserved for the device. When scheduled access (e.g., triggered by a trigger frame) is used to transmit time-sensitive frames, a guard band may be needed to prevent a transmission of best-effort data from delaying the transmission of time time-sensitive data. In this manner, the transmission of a best-effort frame may be interrupted during transmission of the guard band. The guard band may occur before the scheduled TXOP. For example, when a scheduled transmission time is known, a guard band may be set according to the beginning of the scheduled transmission time.

In one or more embodiments, a preemptable transmission opportunities system may facilitate enhancements to the IEEE 802.11 technical standards' MAC definitions to enable an express service for time-sensitive data frames through the introduction of frame preemption capabilities. The following new MAC capabilities are described.

Express queue (EQ) and preemptable queues: A new express queue is introduced for time-sensitive frames that may use the preemption service, and other existing queues may be classified as preemptable.

MAC Preemption Function: This function may receive inputs from the Express queue or a time-sensitive scheduler (e.g., when time-aware scheduling is used) to determine when a time-sensitive frame is available or will be available for transmission during a TXOP. The MAC preemption function may determine whether frame preemption should be applied, and may determine which preemption options should be used. The function may identify information about time-sensitive frames available or expected to arrive soon, and based on that information, may decide to adapt a data frame selected for transmission once a TXOP is acquired in order to minimize the worst case latency for time-sensitive frames. When no time-sensitive frame is available or is expected to arrive in the upcoming TXOP, there is no change required in the normal operation of the 802.11 MAC.

In one or more embodiments, the use of preemption functions may be detected using a wireless packet sniffer. When a system is to transmit a substantial amount of data, time-sensitive packets may be set at a periodic interval. A packet sniffer may detect a delay between the end of a previous packet and the beginning of a next packet. The delay may correspond to anticipation of arrival of a time-sensitive packet according to TSN schedule information, which may indicate that the preemption capability is being used.

In one or more embodiments, time-sensitive packets may be indicated by higher layers of the communication stack (e.g., based on user priority), and corresponding MSDU's may be identified to use express (e.g., preemptive) service. A time-sensitive packet may have a deadline for transmission/arrival, which may be known to the MAC (e.g., based on initial admission control procedures). When a scheduled operation is used for time-sensitive traffic, a scheduler may define an expected frame arrival time. A scheduler may provide input to a MAC preemption function.

In one or more embodiments, to enable MAC frame preemption, new components may be added to IEEE 802.11 MAC architecture. A MSDU classification module, an express frame queue, a MAC preemption function, and a time-aware schedule (e.g., indicating scheduled times for express/TSN traffic) may be added to the MAC, for example. Queues may be configurable to allow for preemption. The MSDU classification module may classify a MSDU received from higher levels of the communication stack. The classification may indicate whether a MSDU is time-sensitive, and when a MSDU is time-sensitive, the MSDU may be placed in a MAC queue (e.g., an enhanced distributed channel access queue or another queue). Any queue may be configured as preemptable or not. When a queue is configured as preemptable, the MSDUs stored in such queues may be considered as preemptable. When a TXOP is acquired for a particular preemptable queue, the TXOP may be considered a preemptable TXOP (pTXOP) and may be subject to the MAC preemption rules. Non-preemptable queues may not be preempted. An express queue (EQ) may store MSDUs that are eligible to use the preemption capability. Once a MSDU is stored in the EQ, the preemptable MSDU storage may trigger a signal to inform the MAC preemption function that a time-sensitive frame is available for transmission and needs express service.

In one or more embodiments, the MAC preemption function may monitor the state of the MAC queues (preemtable and express queues) and enhanced distributed channel access (EDCA) functions. The arrival of a new frame in the EQ may generate a trigger to the MAC preemption function. Additional information associated with the time-sensitive frame arrival may also be stored (e.g., arrival time stamping). The arrival of a new time-sensitive frame in the EQ may trigger one of the following actions:

When all queues are empty when a new frame arrives at the EQ, the MAC preemption function may trigger one of the existing EDCA functions to acquire a TXOP to transmit the frame (if EDCA is being used), or it may wait for the EQ traffic to be scheduled (if a scheduled operation mode is being used).

When preemptable queues are not empty and the EDCA functions are executing regular backoff procedures, the MAC preemption function may monitor the EDCA functions for the first acquired TXOP.

When a new TXOP is acquired and is a considered a preemptable TXOP, the MAC preemption function may decide whether to use preemption within the new TXOP. The decision may be based on the following rules:

When the head of the line (HOL) data frame in the queue corresponding to the winning EDCA function (Access Category—AC) is smaller than a given preemption threshold, the frame may be selected for transmission as in the normal operation (no preemption is used). In this situation, the time-sensitive frame in the EQ may be selected as the next data frame within the TXOP.

When the wining HOL preemptable frame is larger than the preemption threshold, the preemption capability may be used, and the HOL frame in the EQ may be selected for transmission.

Multiple time-sensitive frames may be transmitted up to the maximum duration allowed for the TXOP.

When all frames in the EQ can be transmitted within the TXOP and there is remaining time for transmission, the other (preemptable) data frames may be selected for transmission within the remaining TXOP duration.

In another embodiment, when a new TXOP is acquired and the EQ is empty, and a new time-sensitive frame is expected to arrive within the duration of the acquired TXOP (e.g., based on information about a TSN flow), the MAC preemption function may decide to use preemption within the TXOP according to the following rules:

Preemptable frames may be transmitted within the TXOP up to the expected arrival time of the time-sensitive frame minus a given threshold (e.g., short inter frame space SIFS+internal processing delay) to enable the express service for the time-sensitive frame within the TXOP.

When the size of the preemtable frame is such that its transmission would cause delay for expected time-sensitive frame, the preemptable frame may be fragmented and transmitted without delaying the time sensitive frame.

In one embodiment, the EQ may be defined as one of the existing EDCA queues and its parameters may be set in order to get higher access priority to the medium. In this situation, the preemption procedures described above may apply to allow the EQ frames to be transmitted at the earliest TXOP acquired.

The MAC preemption function may be used in AP and non-AP station devices (STAs). When used in the AP, the MAC preemption function also may be used to preempt STA transmissions in the uplink direction when the AP is operating in the scheduled mode (OFDMA/triggered based access as defined in 802.11ax). In this situation, when the AP acquires a TXOP, the AP may decide to preempt its own DL transmissions based on the state of EQs or expected arrival times in the STAs. For instance, the AP may decide to preempt a best effort downlink frame in order to trigger a time-sensitive UL transmission(s) from one or more STAs. Similar rules (as described above) may be used by the MAC preemption function to decide if/how to use the preemption capability.

In another embodiment, when a station (AP or non-AP STA) has gained a TXOP and started to transmit an A-MPDU for a given duration (e.g., 5 msec), and in the middle of this transmission the device receives a packet in the EQ, the AP may directly insert the time-sensitive MPDU in the A-MPDU that is left to be transmitted. The AP may replace one or more of the MPDUs that was planned for transmission of the time-sensitive MPDU from the EQ. In order to ensure the A-MPDU may be transmitted within the duration of the acquired TXOP, the last MPDU may be fragmented. In order to enable such feature, a new express service interface and primitives may be defined between the MAC and PHY to enable the exchange of MPDUs on the fly as well as fragmentation of MPDUs within an A-MPDU.

In another embodiment, when a deterministic schedule of time-sensitive frames is not known, a device's pattern recognition component may be used to extract TSN traffic pattern information without explicit configuration. The pattern recognition component may analyze the cadence of TSN packets using various methods, including but not limited to machine learning (ML), pattern recognition, time between consecutive packets averring etc. The module may provide input to MAC Preemption Function when the next TSN packets should be expected. Multiple TSN packet schedules may be recognized based on packet's origin/destination or application specific characteristics.

Some advantages of the proposed solutions include reduced worst-case latency and increased efficiency through smaller guard bands for scheduled traffic. The solutions described herein may enable time-sensitive networking and other real-time applications (e.g., gaming, AR/VR, etc.) in the next generation of IEEE 802.11be. With the solutions presented herein, applications may experience minimal medium access latency and cut-through performance over Wi-Fi networks, similar to TSN Ethernet switches. The proposed solutions may also be implemented by Wi-Fi radios.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

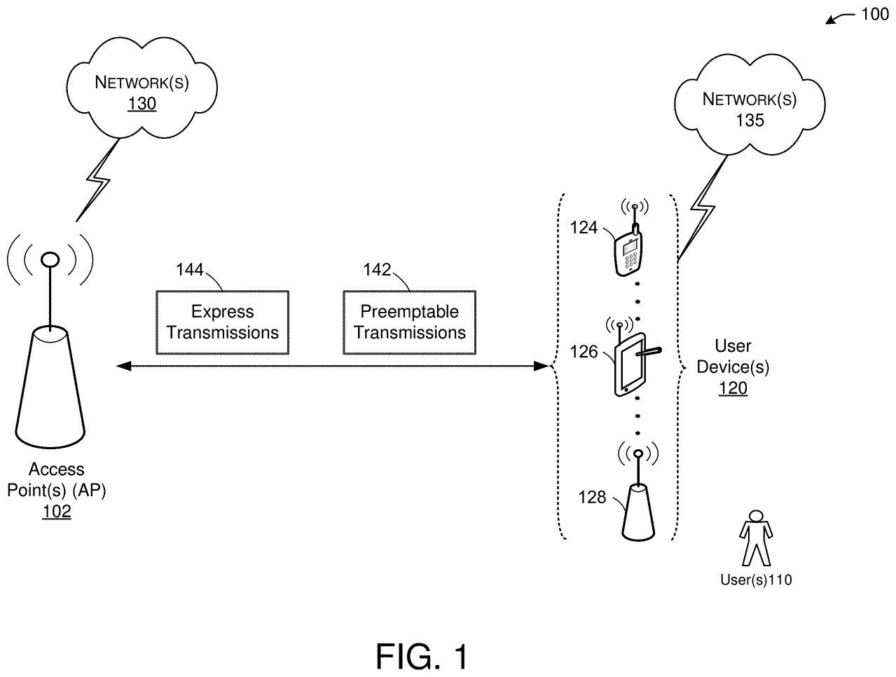

FIG. 1 is a network diagram illustrating an example network environment of preemptable transmission opportunities, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

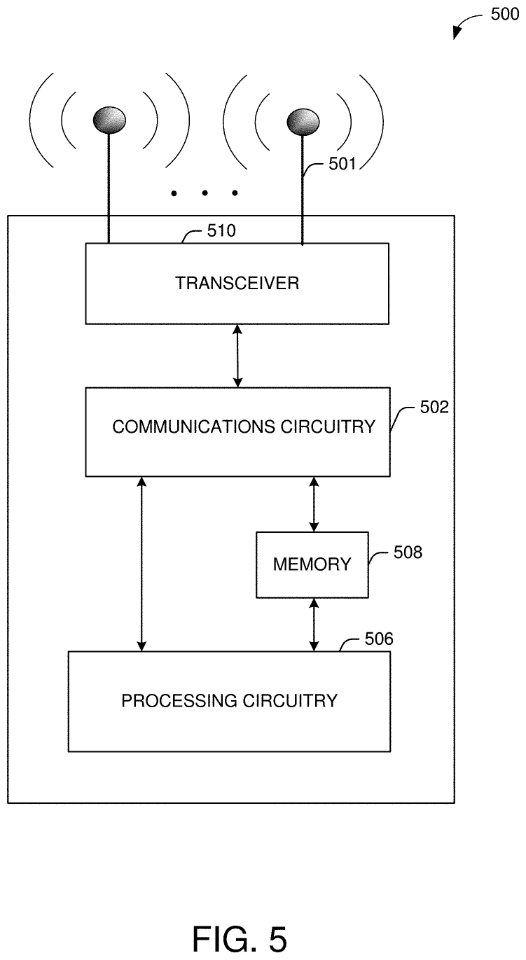

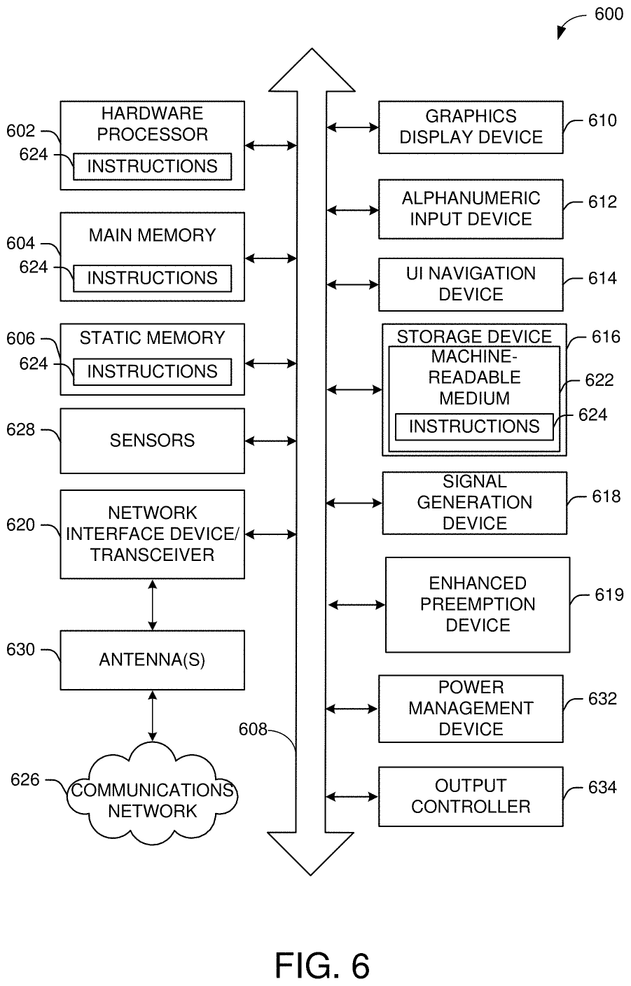

In some embodiments, the user devices 120 and the AP 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, the AP(s) 102 and the user device(s) 120 may send preemptable transmission 142 (e.g., non-time-sensitive transmissions) and express transmissions 144 (e.g., time-sensitive transmissions whose transmissions may preempt the transmissions of the preemptable transmission 142).

It is understood that the above descriptions are for purposes of illustration and are not meant to be limiting.

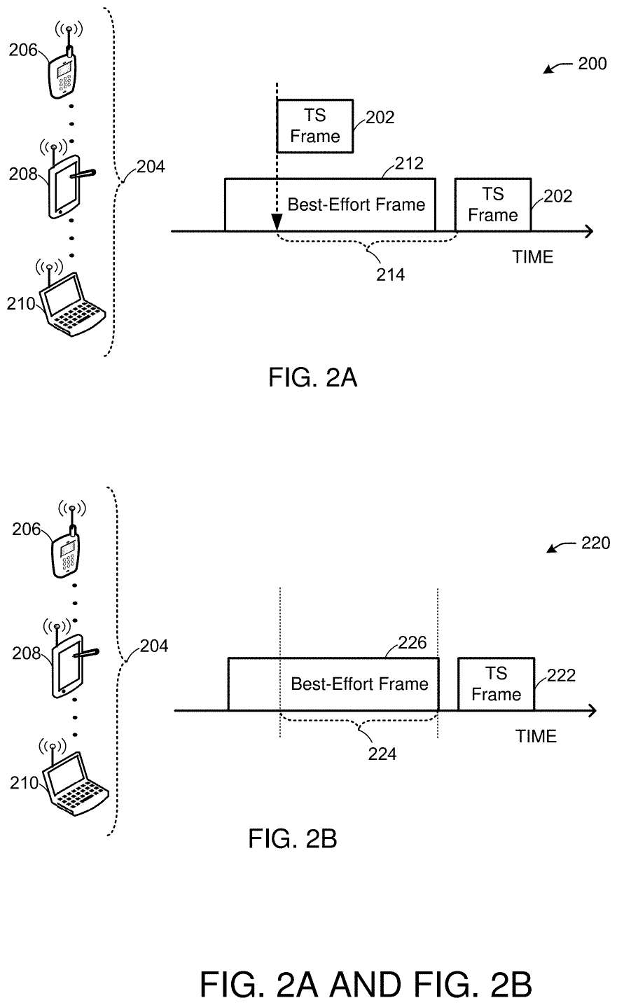

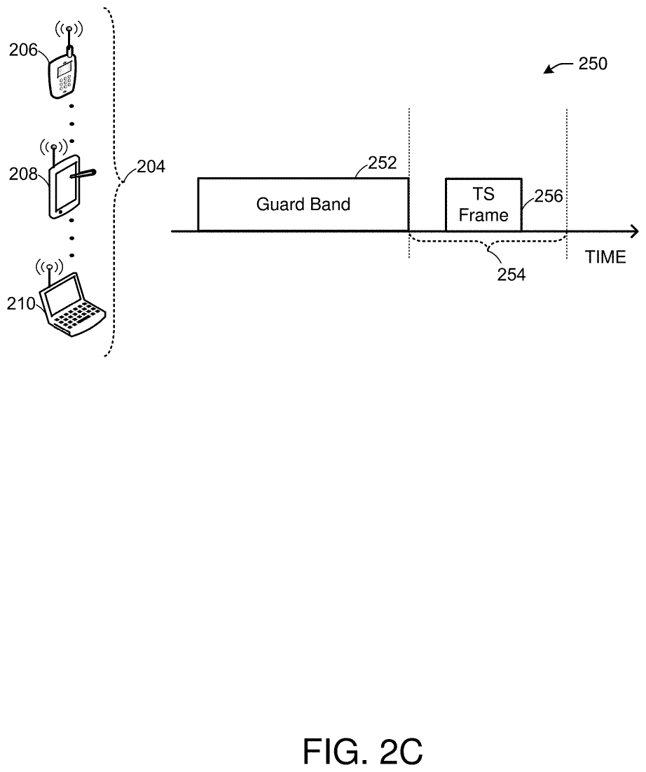

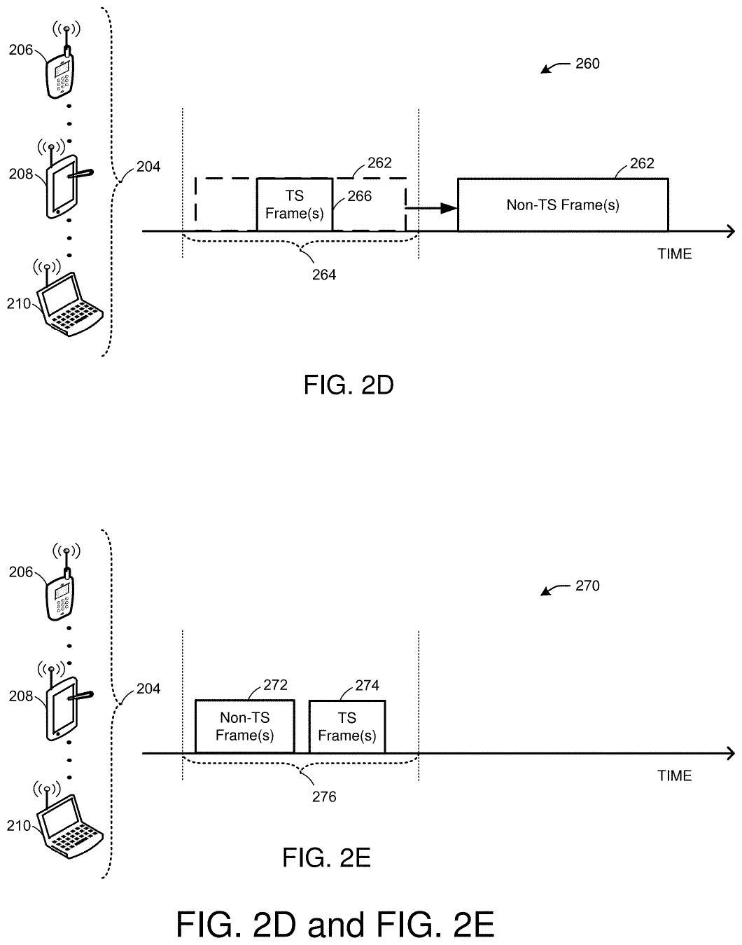

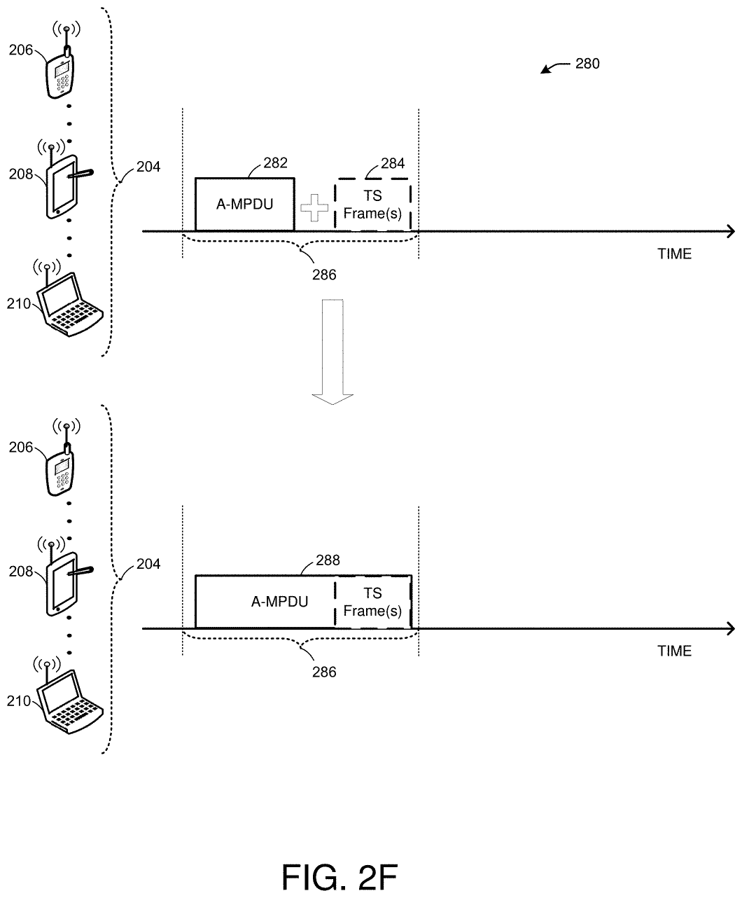

FIG. 2A depicts an example time-sensitive transmission process 200, in accordance with one or more example embodiments of the present disclosure.

Referring to FIG. 2A, a time-sensitive (TS) frame 202 may arrive at device(s) 204 (e.g., 206, 208, 210) during transmission of a non-TS frame (e.g., best-effort frame 212), causing processing of the TS frame 202 to be delayed (e.g., as indicated by the latency 214 from the arrival of the TS frame 202 to a time after the transmission of the best-effort frame 212).

FIG. 2B depicts an example time-sensitive transmission process 220, in accordance with one or more example embodiments of the present disclosure.

Referring to FIG. 2B, the device(s) 204 may be scheduled to transmit a TS frame 222 during a TXOP 224, but the transmission of the TS frame 222 may be delayed due to transmission of a non-TS frame (e.g., best effort frame 226). In this manner, the TS frame 222 may miss its intended delivery time, undermining a TS operation that relies on the TS frame 222. To avoid such latency issues shown in FIGS. 2A and 2B, a guard band may be used, as shown in FIG. 2C.

FIG. 2C depicts an example time-sensitive transmission process 250, in accordance with one or more example embodiments of the present disclosure.

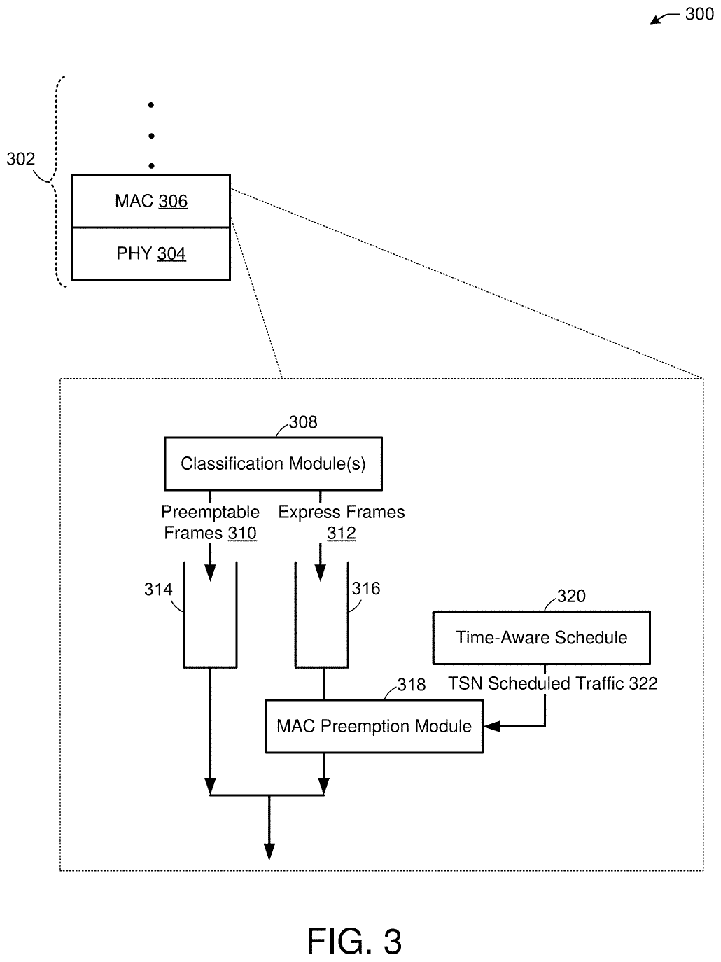

Referring to FIG. 2C, a guard band 252 may be scheduled for time preceding a TXOP 254 (e.g., a TXOP during which TS frame 256 is scheduled to be transmitted) for the device(s) 204. The size of the guard band 252 (e.g., length in time) may be based on the size of any non-TS frames (e.g., at least the size of a largest non-TS frame, such as the best-effort frame 226 of FIG. 2B). In this manner, transmission of a non-TS frame may be avoided in the time leading up to the TXOP 254 for transmission of the TS frame 256 because the guard band 252 may prevent a non-TS transmission during such time. To provide such MAC layer preemption, an enhanced MAC layer may be provided, as shown in FIG.3.

FIG. 2D depicts an example time-sensitive transmission process 260, in accordance with one or more example embodiments of the present disclosure.

Referring to FIG. 2D, the device(s) 204 may preempt the transmission of one or more non-TS frames 262 during TXOP 264 based on an identification of one or more TS frames 266 to be transmitted. When the one or more non-TS frames 262 have a length (e.g., time duration) that exceeds a threshold, the device(s) 204 may preempt transmission of the one or more non-TS frames 262 until after the TXOP 264 concludes, and then may send the one or more non-TS frames 262.

FIG. 2E depicts an example time-sensitive transmission process 270, in accordance with one or more example embodiments of the present disclosure.

Referring to FIG. 2E, the device(s) 204 may identify one or more non-TS frames 272 and one or more TS frames 2724 to be transmitted during a TXOP 276. When the one or more non-TS frames 272 fail to exceed a size (e.g., time duration) threshold, the device(s) 204 may send the one or more non-TS frames 272 during the TXOP without preemption. In this manner, the one or more non-TS frames 272 and the one or more TS frames 274 may be transmitted during the TXOP 276.

FIG. 2F depicts an example time-sensitive transmission process 280, in accordance with one or more example embodiments of the present disclosure.

Referring to FIG. 2F, the device(s) 204 may begin transmission of a A-MPDU 282 (or other aggregated frame), and may identify one or more TS frames 284 to be transmitted during a TXOP 286, the device(s) 204 may insert the one or more TS frames 284 into the A-MPDU 282, forming A-MPDU 288. To ensure that the A-MPDU 288 may be transmitted within the duration of the TXOP 286 (e.g., that the A-MPDU 288 with the addition of the one or more TS frames 284 is not too long that it cannot be transmitted during the TXOP 286), the last MPDU of the A-MPDU 288 may be fragmented.

Referring to FIGS. 2A-2F, the device(s) may be APs or STAs.

FIG. 3 depicts an example schematic 300 of an enhanced communication layer stack of a device used for transmission preemption, in accordance with one or more example embodiments of the present disclosure.

Referring to FIG. 3, communication stack layers 302 of a wireless device (e.g., the AP(s) 102 of FIG. 1, the device(s) 120 of FIG. 1, the device(s) 204 of FIGS. 2A-2C) may include a PHY layer 304, a MAC layer 306, and other higher-level layers. To provide for MAC layer TXOP preemption of Wi-Fi communications, the MAC layer 306 may be enhanced by including one or more classification modules 308, which may classify MAC frames (e.g., MSDUs) as preemptable frames 310 (e.g., non-TS frames) and express frames 312 (e.g., TS frames that may preempt the preemptable frames 310. The preemptable frames 310 may be stored in one or more preemptable queues 314 of the MAC layer 306, and the express frames 312 may be stored in one or more express queues 316 of the MAC layer 306. To coordinate preemption of transmission of the preemptable frames 310, the MAC layer 306 may include a MAC preemption module 318, which may control the transmission timing of frames in the queues. MAC layer 306 may include a time-aware schedule 320, which may provide TSN scheduled traffic 322 (e.g., scheduled tiems for express TSN traffic, such as the express frames 312) to the MAC preemption module 318. The MAC preemption module 318 may identify when an express frame of the express frames 312 is to be transmitted (e.g., using the TSN scheduled traffic 322), and may preempt transmission of non-TS frames in the one or more preemptable queues 314 at that time (e.g., by scheduling a guard band before the TXOP of an express frame).

When a MSDU is received at the MAC layer 306 from higher layers of the communication stack layers 302, the MDSU may be classified by the one or more classification modules 308 as a time-sensitive MSDU that is eligible to use the express service, it is inserted in the one or more express queues 316. When a MSDU is not eligible for express service, the MDSU may be classified by the one or more classification modules 308 and may be placed in the one or more preemptable queues 314. In one or more embodiments, TS packets may be indicated by higher layers of the communication stack layers 302 (e.g., based on user priority of a user device sending the packet), and corresponding MSDU's may be identified to use express (e.g., preemptive) service. A TS packet may have a deadline for transmission/arrival, which may be known to the MAC layer 306 (e.g., based on initial admission control procedures). When a scheduled operation is used for TS traffic, the time-aware schedule 320 may define an expected frame arrival time. In this manner, a MAC packet may be received from another layer on the same device and may include an indication of whether the packet is TS or not. The indicator may be explicit, or may be based on a transmission/arrival deadline indicated by the packet. When the one or more classification modules 308 identify the TS or non-TS identifier, the one or more classification modules 308 may classify the packet and send the packet to a corresponding queue. The MAC preemption module 318 may determine when the time to transmit a TS packet occurs, and may preempt transmission of non-TS packets.

The queues of the MAC layer 306 may be configured as preemptable or not. If a queue is configured as preemptable, the MSDUs stored in such queues maybe considered preemptable. When a TXOP is acquired for a particular preemptable queue, the TXOP may be considered a preemptable TXOP (pTXOP) subject to MAC preemption rules of the MAC preemption module 318. If the queue is not classified as preemptable, its MSDUs may not be preempted.

The one or more express queues 316 may store the express frames 312 eligible to use the preemption capability. Once an express frame is stored in the one or more express queues 316, it triggers a signal to inform the MAC preemption module 318 that a TS frame is available for transmission and needs express service. The MAC preemption module 318 may identify the time when the TS frame may be sent, and if a preemptable frame is being transmitted at that time, the MAC preemption module 318 may preempt the transmission of the preemptable frame to allow for transmission of the TS frame.

The MAC preemption module 318 may monitor the state of the MAC queues (preemtable and express queues) and any EDCA functions. The arrival of a new frame in the one or more express queues 316 may generate a trigger to the MAC preemption module 318.

The arrival of a new time-sensitive frame in the one or more express queues 316 may trigger one of the following actions:

If all queues are empty when a new frame arrives at the one or more express queues 316, the MAC preemption module 318 may trigger an EDCA function to acquire a TXOP to transmit the frame (if EDCA is being used), or it may wait for the one or more express queues 316 traffic to be scheduled (if a scheduled operation mode is being used).

If the one or more preemptable queues 314 are not empty and the EDCA functions are executing their regular backoff procedures, the MAC preemption module 318 may monitor EDCA functions to identify the first acquired TXOP.

When a new TXOP is acquired and is a considered a preemptable TXOP, the MAC preemption module 318 may determine whether to use preemption within the new TXOP. The decision may be based on the following rules:

If the head of the line (HOL) data frame in the queue corresponding to the winning EDCA function (Access Category—AC) is smaller than a given preemption size threshold, the frame is selected for transmission as in the normal operation (no preemption is used). In this situation, the time-sensitive frame in the one or more express queues 316 may be selected as the next data frame within the TXOP.

If the wining HOL preemptable frame is larger than the preemption threshold size, the preemption capability may be used, and the HOL frame in the one or more express queues 316 may be selected for transmission.

Multiple time-sensitive frames may be transmitted up to the maximum duration allowed for the TXOP.

If all frames in the one or more express queues 316 can be transmitted within the TXOP and there is remaining time for transmission, the other (preemptable) data frames may be selected for transmission within the remaining TXOP duration.

In another embodiment, when a new TXOP is acquired and the one or more express queues 316 are empty, and a new TS frame is expected to arrive within the duration of the acquired TXOP (e.g., based on information about a TSN flow), the MAC preemption module 318 may determine to use preemption within the TXOP according to the following rules:

Preemptable frames may be transmitted within the TXOP up to the expected arrival time of the TS frame minus a given threshold (e.g., SIFS+internal processing delay) to enable the express service for the TS frame within the TXOP.

If the size of the preemptable frame is such that its transmission would cause delay for expected time-sensitive frame, the preemptable frame may be fragmented and transmitted without delaying the time sensitive frame.

In one embodiment, the one or more express queues 316 may be defined as an EDCA queue and its AC parameters may be set in order to get higher access priority to the medium. In this situation, the preemption procedures described above may apply as they allow the express frames 312 to be transmitted at the earliest TXOP acquired.

The MAC preemption module 318 may be implemented in AP and non-AP STAs. When used in the AP, the MAC preemption module 318 can also be used to preempt STA transmissions in the uplink direction when the AP is operating in the scheduled mode (OFDMA/triggered based access as defined in 802.11ax). In this case, when the AP acquires a TXOP, the AP may preempt its own DL transmissions based on the state of the one or more express queues 316 or expected arrival times of the STAs. For example, the AP may decide to preempt a best effort downlink frame in order to trigger a TS uplink(UL) transmission(s) from one or more STAs. Similar rules (as described above) may be used by the MAC preemption module 318 to decide when/how to implement the preemption capability.

In another embodiment, where a STA (AP or non-AP STA) has gained a TXOP and started to transmit an aggregated MPDU (A-MPDU) for a given duration (e.g., 5 msec), and during the TXOP the STA receives a packet in the one or more express queues 316, the AP may directly insert the time-sensitive MPDU in the A-MPDU that is left to be transmitted. The AP may replace one or more of the MPDUs that were planned for transmission of the time-sensitive MPDU from the one or more express queues 316. In order to ensure the A-MPDU may still be transmitted within the duration of the acquired TXOP, the last MPDU may be fragmented. In order to enable such feature, a new express service interface and primitives may be defined between the MAC layer 306 and the PHY layer 304 to enable the exchange of MPDUs on the fly as well as fragmentation of MPDUs within an A-MPDU.

In another embodiment, if a deterministic schedule of time-sensitive frames is not known, a pattern recognition component (not shown) of the MAC layer 306 be implemented to extract TSN traffic pattern information without explicit configuration. The pattern recognition component may analyze the cadence of TSN packets using various methods, including but not limited to ML, pattern recognition, time between consecutive packets averring etc. The pattern recognition component may include a module that may provide input to MAC preemption module 318 indicating when the next TSN packets should be expected. Multiple TSN packet schedules may be recognized based on packet origin/destination and/or application-specific characteristics.

It is understood that the above descriptions are for purposes of illustration and are not meant to be limiting.

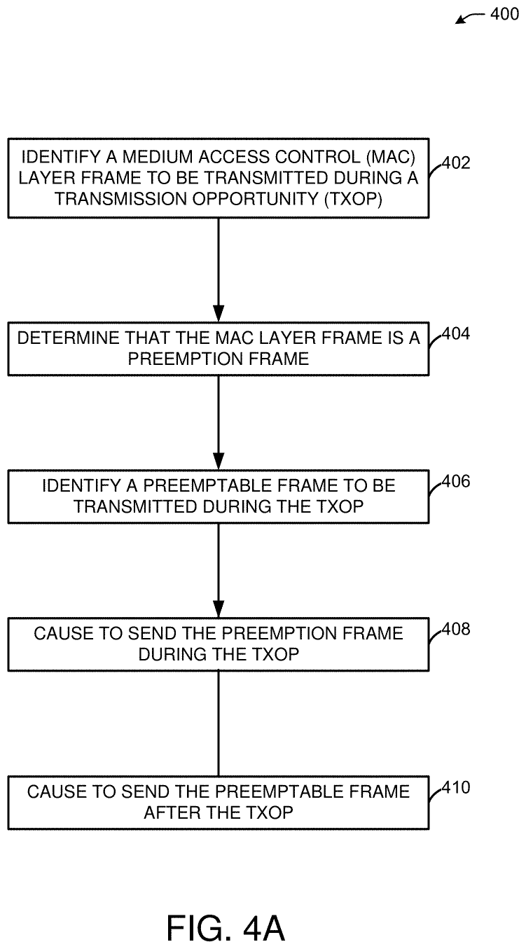

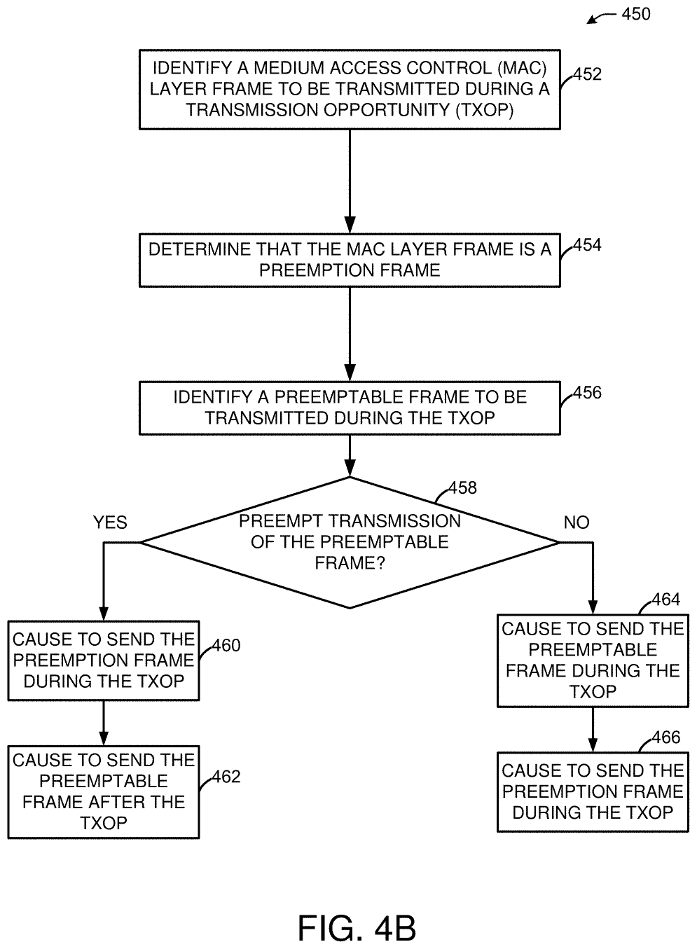

FIG. 4A illustrates a flow diagram of illustrative process 400 for a MAC layer TXOP preemption, in accordance with one or more example embodiments of the present disclosure.

At block 402, a device (e.g., the user device(s) 120 and/or the AP 102 of FIG. 1, the device(s) 204 of FIGS. 2A-2F, having the MAC layer 306 of FIG. 3) may identify a MAC layer frame to be transmitted during a TXOP (e.g., the one or more TS frames 266 of FIG. 2D, representing an express frame of the express frames 312 of FIG. 3, identified in the one or more one or more express queues 316 of FIG. 3).

At block 404, the device may determine that the MAC layer frame is preemption frame (e.g., express/TS frame). The device may receive the frame from a higher layer of a communication stack (e.g., the communication stack layers 302 of FIG. 3), and the frame may include an express indication that the frame is a preemption frame. Alternatively, the device may determine that the frame has an expected transmission or arrival time (e.g., based on scheduling information such as the time-aware schedule 320 of FIG. 3). Alternatively, when a deterministic schedule of time-sensitive frames is not known, the device may extract TSN traffic pattern information without explicit configuration. The device may analyze the cadence of TSN packets using various methods, including but not limited to machine learning (ML), pattern recognition, time between consecutive packets averring etc.

At block 406, the device may identify a preemptable frame to be transmitted during the TXOP. The preemptable frame (e.g., the one or more non-TS frames 262 of FIG. 2D) may be identified in queue that is configured as preemptable (e.g., the one or more preemptable queues 314 of FIG. 3), or the preemptable frame may be in the process of being transmitted when the device identifies the preemption frame at block 404. Because the preemptable frame may be prioritized lower than the preemption frame, transmission (in whole or in part) of the preemptable frame may be preempted to allow for transmission of the preemption frame.

At block 408, the device may cause to send the preemption frame (and any other identified preemption frames available) during the TXOP, preempting the transmission of the preemptable frame during that time. At block 410, the device may cause to send the preemptable frame after transmission of the preemption frame (e.g., during or after the TXOP). In this manner, the transmission of the preemptable frame may be preempted until after transmission of the preemption frame.

FIG. 4B illustrates a flow diagram of illustrative process 450 for a MAC layer TXOP preemption, in accordance with one or more example embodiments of the present disclosure.

At block 452, a device (e.g., the user device(s) 120 and/or the AP 102 of FIG. 1, the device(s) 204 of FIGS. 2A-2F, having the MAC layer 306 of FIG. 3) may identify a MAC layer frame to be transmitted during a TXOP (e.g., the one or more TS frames 266 of FIG. 2D, representing an express frame of the express frames 312 of FIG. 3, identified in the one or more one or more express queues 316 of FIG. 3).

At block 454, the device may determine that the MAC layer frame is preemption frame (e.g., express/TS frame). The device may receive the frame from a higher layer of a communication stack (e.g., the communication stack layers 302 of FIG. 3), and the frame may include an express indication that the frame is a preemption frame. Alternatively, the device may determine that the frame has an expected transmission or arrival time (e.g., based on scheduling information such as the time-aware schedule 320 of FIG. 3). Alternatively, when a deterministic schedule of time-sensitive frames is not known, the device may extract TSN traffic pattern information without explicit configuration. The device may analyze the cadence of TSN packets using various methods, including but not limited to machine learning (ML), pattern recognition, time between consecutive packets averring etc.

At block 456, the device may identify a preemptable frame to be transmitted during the TXOP. The preemptable frame (e.g., the one or more non-TS frames 262 of FIG. 2D) may be identified in queue that is configured as preemptable (e.g., the one or more preemptable queues 314 of FIG. 3), or the preemptable frame may be in the process of being transmitted when the device identifies the preemption frame at block 454. Because the preemptable frame may be prioritized lower than the preemption frame, transmission (in whole or in part) of the preemptable frame may be preempted to allow for transmission of the preemption frame.

At block 458, the device may determine whether to preempt transmission of the preemptable frame. For example, the decision whether to preempt transmission of the preemptable frame may be based on a determination of whether the preemptable frame and the preemption frame may be transmitted during the TXOP. The device may compare the size (e.g., duration) of the preemptable frame to a size threshold. When the size of the preemptable frame exceeds the size threshold, transmission of the preemptable frame may be preempted, and the device may continue to block 460 and block 462. When the size of the preemptable frame fails to exceed the size threshold, such may indicate that the preemptable frame is small enough to be transmitted during the TXOP without causing the preemption frame to miss a TS transmission/arrival time. When the preemptable frame does not need to be preempted, the device may continue to block 464 and to block 466. Other than size, the device may consider whether the preemptable frame is an aggregated frame (e.g., the A-MPDU 282 of FIG. 2F) and whether the preemption frame may be added to (e.g., inserted into) the aggregated frame. If so, the device may continue to block 464 and to block 466.

At block 460, transmission of the preemptable frame may be preempted to facilitate transmission of the preemption frame during the TXOP. The device may cause to send the preemption frame during the TXOP. At block 462, the device may cause to send the preemptable frame after the TXOP, or at least after the transmission of the preemption frame.

At block 464, the device may cause to send the preemptable frame during the TXOP (or continue transmission of the preemptable frame). At block 466, the device may cause to send the preemption frame during the TXOP. When using an aggregated frame, blocks 464 and 466 may be combined into a step of sending an aggregated frame that includes the preemption frame.

It is understood that the above descriptions are for purposes of illustration and are not meant to be limiting.

FIG. 5 shows a functional diagram of an exemplary communication station 500, in accordance with one or more example embodiments of the present disclosure. In one embodiment, FIG. 5 illustrates a functional block diagram of a communication station that may be suitable for use as an AP 102 (FIG. 1) or a user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an enahnced preemption device 619 (e.g., having the functionality of the MAC layer 306 of FIG. 3 and capable of performing the processes of FIG. 4A and FIG. 4B), a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 602 for generation and processing of the baseband signals and for controlling operations of the main memory 604, the storage device 616, and/or the preemptable transmission opportunities device 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced preemption device 619 may carry out or perform any of the operations and processes (e.g., process 400 of FIG. 4A, process 450 of FIG. 4B) described and shown above.

It is understood that the above are only a subset of what the enhanced preemption device 619 may be configured to perform and that other functions included throughout this disclosure may also be performed by the enhanced preemption device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

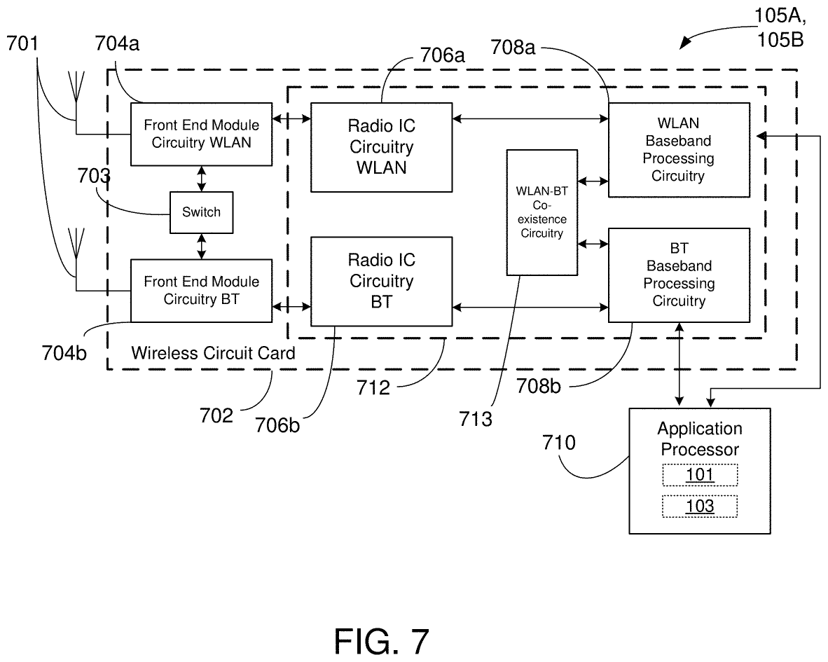

FIG. 7 is a block diagram of a radio architecture 105A, 105B in accordance with some embodiments that may be implemented in any one of the example AP 102 and/or the example STA 120 of FIG. 1. Radio architecture 105A, 105B may include radio front-end module (FEM) circuitry 704a-b, radio IC circuitry 706a-b and baseband processing circuitry 708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 704a-b may include a WLAN or Wi-Fi FEM circuitry 704a and a Bluetooth (BT) FEM circuitry 704b. The WLAN FEM circuitry 704a may include a receive signal path comprising circuitry configured to operate on WLAN RF signals received from one or more antennas 701, to amplify the received signals and to provide the amplified versions of the received signals to the WLAN radio IC circuitry 706a for further processing. The BT FEM circuitry 704b may include a receive signal path which may include circuitry configured to operate on BT RF signals received from one or more antennas 701, to amplify the received signals and to provide the amplified versions of the received signals to the BT radio IC circuitry 706b for further processing. FEM circuitry 704a may also include a transmit signal path which may include circuitry configured to amplify WLAN signals provided by the radio IC circuitry 706a for wireless transmission by one or more of the antennas 701. In addition, FEM circuitry 704b may also include a transmit signal path which may include circuitry configured to amplify BT signals provided by the radio IC circuitry 706b for wireless transmission by the one or more antennas. In the embodiment of FIG. 7, although FEM 704a and FEM 704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 706a-b as shown may include WLAN radio IC circuitry 706a and BT radio IC circuitry 706b. The WLAN radio IC circuitry 706a may include a receive signal path which may include circuitry to down-convert WLAN RF signals received from the FEM circuitry 704a and provide baseband signals to WLAN baseband processing circuitry 708a. BT radio IC circuitry 706b may in turn include a receive signal path which may include circuitry to down-convert BT RF signals received from the FEM circuitry 704b and provide baseband signals to BT baseband processing circuitry 708b. WLAN radio IC circuitry 706a may also include a transmit signal path which may include circuitry to up-convert WLAN baseband signals provided by the WLAN baseband processing circuitry 708a and provide WLAN RF output signals to the FEM circuitry 704a for subsequent wireless transmission by the one or more antennas 701. BT radio IC circuitry 706b may also include a transmit signal path which may include circuitry to up-convert BT baseband signals provided by the BT baseband processing circuitry 708b and provide BT RF output signals to the FEM circuitry 704b for subsequent wireless transmission by the one or more antennas 701. In the embodiment of FIG. 7, although radio IC circuitries 706a and 706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 708a-b may include a WLAN baseband processing circuitry 708a and a BT baseband processing circuitry 708b. The WLAN baseband processing circuitry 708a may include a memory, such as, for example, a set of RAM arrays in a Fast Fourier Transform or Inverse Fast Fourier Transform block (not shown) of the WLAN baseband processing circuitry 708a. Each of the WLAN baseband circuitry 708a and the BT baseband circuitry 708b may further include one or more processors and control logic to process the signals received from the corresponding WLAN or BT receive signal path of the radio IC circuitry 706a-b, and to also generate corresponding WLAN or BT baseband signals for the transmit signal path of the radio IC circuitry 706a-b. Each of the baseband processing circuitries 708a and 708b may further include physical layer (PHY) and medium access control layer (MAC) circuitry, and may further interface with a device for generation and processing of the baseband signals and for controlling operations of the radio IC circuitry 706a-b.

Referring still to FIG. 7, according to the shown embodiment, WLAN-BT coexistence circuitry 713 may include logic providing an interface between the WLAN baseband circuitry 708a and the BT baseband circuitry 708b to enable use cases requiring WLAN and BT coexistence. In addition, a switch 703 may be provided between the WLAN FEM circuitry 704a and the BT FEM circuitry 704b to allow switching between the WLAN and BT radios according to application needs. In addition, although the antennas 701 are depicted as being respectively connected to the WLAN FEM circuitry 704a and the BT FEM circuitry 704b, embodiments include within their scope the sharing of one or more antennas as between the WLAN and BT FEMs, or the provision of more than one antenna connected to each of FEM 704a or 704b.

In some embodiments, the front-end module circuitry 704a-b, the radio IC circuitry 706a-b, and baseband processing circuitry 708a-b may be provided on a single radio card, such as wireless radio card 702. In some other embodiments, the one or more antennas 701, the FEM circuitry 704a-b and the radio IC circuitry 706a-b may be provided on a single radio card. In some other embodiments, the radio IC circuitry 706a-b and the baseband processing circuitry 708a-b may be provided on a single chip or integrated circuit (IC), such as IC 712.

In some embodiments, the wireless radio card 702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

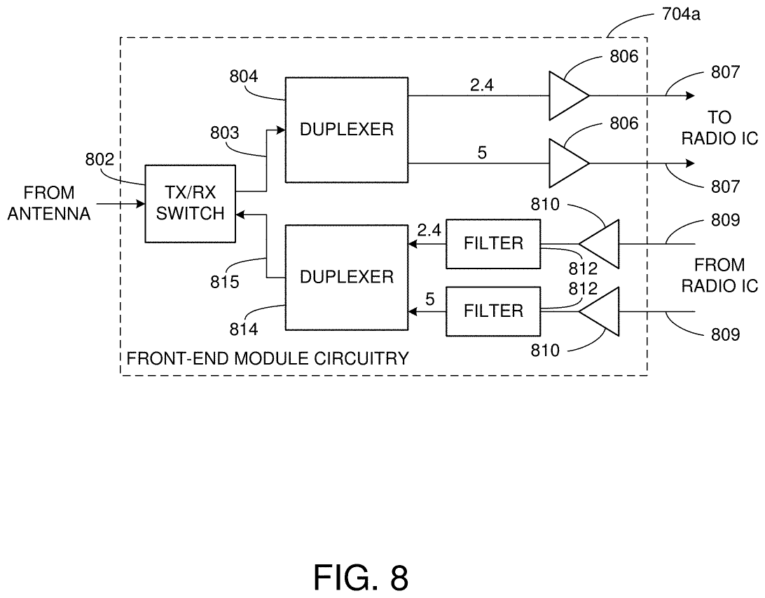

FIG. 8 illustrates WLAN FEM circuitry 704a in accordance with some embodiments. Although the example of FIG. 8 is described in conjunction with the WLAN FEM circuitry 704a, the example of FIG. 8 may be described in conjunction with the example BT FEM circuitry 704b (FIG. 7), although other circuitry configurations may also be suitable.

In some embodiments, the FEM circuitry 704a may include a TX/RX switch 802 to switch between transmit mode and receive mode operation. The FEM circuitry 704a may include a receive signal path and a transmit signal path. The receive signal path of the FEM circuitry 704a may include a low-noise amplifier (LNA) 806 to amplify received RF signals 803 and provide the amplified received RF signals 807 as an output (e.g., to the radio IC circuitry 706a-b (FIG. 7)). The transmit signal path of the circuitry 704a may include a power amplifier (PA) to amplify input RF signals 809 (e.g., provided by the radio IC circuitry 706a-b), and one or more filters 812, such as band-pass filters (BPFs), low-pass filters (LPFs) or other types of filters, to generate RF signals 815 for subsequent transmission (e.g., by one or more of the antennas 701 (FIG. 7)) via an example duplexer 814.

In some dual-mode embodiments for Wi-Fi communication, the FEM circuitry 704a may be configured to operate in either the 2.4 GHz frequency spectrum or the 5 GHz frequency spectrum. In these embodiments, the receive signal path of the FEM circuitry 704a may include a receive signal path duplexer 804 to separate the signals from each spectrum as well as provide a separate LNA 806 for each spectrum as shown. In these embodiments, the transmit signal path of the FEM circuitry 704a may also include a power amplifier 810 and a filter 812, such as a BPF, an LPF or another type of filter for each frequency spectrum and a transmit signal path duplexer 804 to provide the signals of one of the different spectrums onto a single transmit path for subsequent transmission by the one or more of the antennas 701 (FIG. 7). In some embodiments, BT communications may utilize the 2.4 GHz signal paths and may utilize the same FEM circuitry 704a as the one used for WLAN communications.

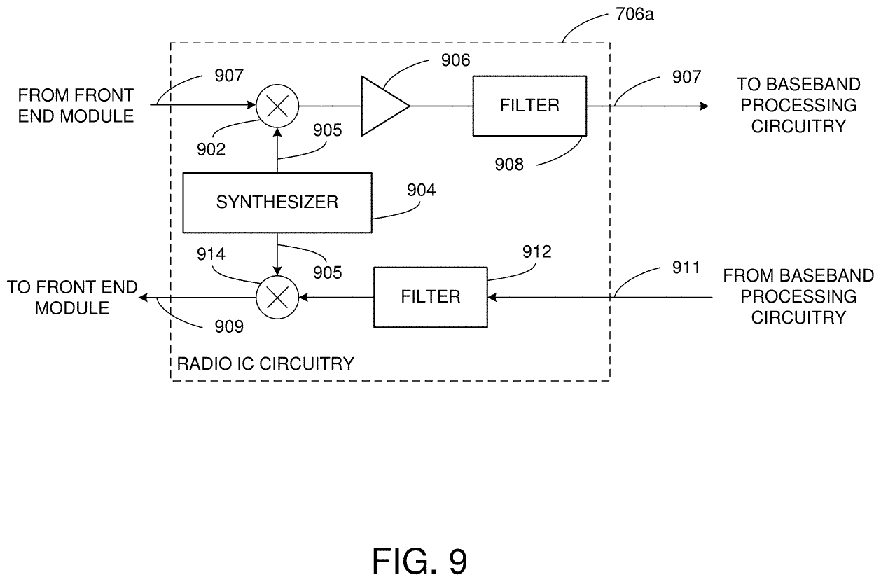

FIG. 9 illustrates radio IC circuitry 706a in accordance with some embodiments. The radio IC circuitry 706a is one example of circuitry that may be suitable for use as the WLAN or BT radio IC circuitry 706a/706b (FIG. 7), although other circuitry configurations may also be suitable. Alternatively, the example of FIG. 9 may be described in conjunction with the example BT radio IC circuitry 706b.

In some embodiments, the radio IC circuitry 706a may include a receive signal path and a transmit signal path. The receive signal path of the radio IC circuitry 706a may include at least mixer circuitry 902, such as, for example, down-conversion mixer circuitry, amplifier circuitry 906 and filter circuitry 908. The transmit signal path of the radio IC circuitry 706a may include at least filter circuitry 912 and mixer circuitry 914, such as, for example, up-conversion mixer circuitry. Radio IC circuitry 706a may also include synthesizer circuitry 904 for synthesizing a frequency 905 for use by the mixer circuitry 902 and the mixer circuitry 914. The mixer circuitry 902 and/or 914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 9 illustrates only a simplified version of a radio IC circuitry, and may include, although not shown, embodiments where each of the depicted circuitries may include more than one component. For instance, mixer circuitry 914 may each include one or more mixers, and filter circuitries 908 and/or 912 may each include one or more filters, such as one or more BPFs and/or LPFs according to application needs. For example, when mixer circuitries are of the direct-conversion type, they may each include two or more mixers.

In some embodiments, mixer circuitry 902 may be configured to down-convert RF signals 807 received from the FEM circuitry 704a-b (FIG. 7) based on the synthesized frequency 905 provided by synthesizer circuitry 904. The amplifier circuitry 906 may be configured to amplify the down-converted signals and the filter circuitry 908 may include an LPF configured to remove unwanted signals from the down-converted signals to generate output baseband signals 907. Output baseband signals 907 may be provided to the baseband processing circuitry 708a-b (FIG. 7) for further processing. In some embodiments, the output baseband signals 907 may be zero-frequency baseband signals, although this is not a requirement. In some embodiments, mixer circuitry 902 may comprise passive mixers, although the scope of the embodiments is not limited in this respect.

In some embodiments, the mixer circuitry 914 may be configured to up-convert input baseband signals 911 based on the synthesized frequency 905 provided by the synthesizer circuitry 904 to generate RF output signals 809 for the FEM circuitry 704a-b. The baseband signals 911 may be provided by the baseband processing circuitry 708a-b and may be filtered by filter circuitry 912. The filter circuitry 912 may include an LPF or a BPF, although the scope of the embodiments is not limited in this respect.

In some embodiments, the mixer circuitry 902 and the mixer circuitry 914 may each include two or more mixers and may be arranged for quadrature down-conversion and/or up-conversion respectively with the help of synthesizer 904. In some embodiments, the mixer circuitry 902 and the mixer circuitry 914 may each include two or more mixers each configured for image rejection (e.g., Hartley image rejection). In some embodiments, the mixer circuitry 902 and the mixer circuitry 914 may be arranged for direct down-conversion and/or direct up-conversion, respectively. In some embodiments, the mixer circuitry 902 and the mixer circuitry 914 may be configured for super-heterodyne operation, although this is not a requirement.

Mixer circuitry 902 may comprise, according to one embodiment: quadrature passive mixers (e.g., for the in-phase (I) and quadrature phase (Q) paths). In such an embodiment, RF input signal 807 from FIG. 9 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 905 of synthesizer 904 (FIG. 9). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 807 (FIG. 8) may comprise a balanced signal, although the scope of the embodiments is not limited in this respect. The I and Q baseband output signals may be provided to low-noise amplifier, such as amplifier circuitry 906 (FIG. 9) or to filter circuitry 908 (FIG. 9).

In some embodiments, the output baseband signals 907 and the input baseband signals 911 may be analog baseband signals, although the scope of the embodiments is not limited in this respect. In some alternate embodiments, the output baseband signals 907 and the input baseband signals 911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 904 may be a fractional-N synthesizer or a fractional N/N+1 synthesizer, although the scope of the embodiments is not limited in this respect as other types of frequency synthesizers may be suitable. For example, synthesizer circuitry 904 may be a delta-sigma synthesizer, a frequency multiplier, or a synthesizer comprising a phase-locked loop with a frequency divider. According to some embodiments, the synthesizer circuitry 904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 904 may be provided by a voltage controlled oscillator (VCO), although that is not a requirement. A divider control input may further be provided by either the baseband processing circuitry 708a-b (FIG. 7) depending on the desired output frequency 905. In some embodiments, a divider control input (e.g., N) may be determined from a look-up table (e.g., within a Wi-Fi card) based on a channel number and a channel center frequency as determined or indicated by the example application processor 710. The application processor 710 may include, or otherwise be connected to, one of the example secure signal converter 101 or the example received signal converter 103 (e.g., depending on which device the example radio architecture is implemented in).

In some embodiments, synthesizer circuitry 904 may be configured to generate a carrier frequency as the output frequency 905, while in other embodiments, the output frequency 905 may be a fraction of the carrier frequency (e.g., one-half the carrier frequency, one-third the carrier frequency). In some embodiments, the output frequency 905 may be a LO frequency (fLO).

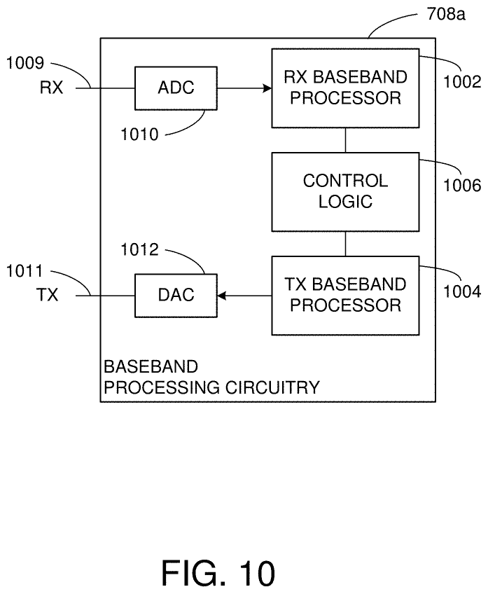

FIG. 10 illustrates a functional block diagram of baseband processing circuitry 708a in accordance with some embodiments. The baseband processing circuitry 708a is one example of circuitry that may be suitable for use as the baseband processing circuitry 708a (FIG. 7), although other circuitry configurations may also be suitable. Alternatively, the example of FIG. 9 may be used to implement the example BT baseband processing circuitry 708b of FIG. 7.

The baseband processing circuitry 708a may include a receive baseband processor (RX BBP) 1002 for processing receive baseband signals 909 provided by the radio IC circuitry 706a-b (FIG. 7) and a transmit baseband processor (TX BBP) 1004 for generating transmit baseband signals 911 for the radio IC circuitry 706a-b. The baseband processing circuitry 708a may also include control logic 1006 for coordinating the operations of the baseband processing circuitry 708a.

In some embodiments (e.g., when analog baseband signals are exchanged between the baseband processing circuitry 708a-b and the radio IC circuitry 706a-b), the baseband processing circuitry 708a may include ADC 1010 to convert analog baseband signals 1009 received from the radio IC circuitry 706a-b to digital baseband signals for processing by the RX BBP 1002. In these embodiments, the baseband processing circuitry 708a may also include DAC 1012 to convert digital baseband signals from the TX BBP 1004 to analog baseband signals 1011.

In some embodiments that communicate OFDM signals or OFDMA signals, such as through baseband processor 708a, the transmit baseband processor 1004 may be configured to generate OFDM or OFDMA signals as appropriate for transmission by performing an inverse fast Fourier transform (IFFT). The receive baseband processor 1002 may be configured to process received OFDM signals or OFDMA signals by performing an FFT. In some embodiments, the receive baseband processor 1002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 7, in some embodiments, the antennas 701 (FIG. 7) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: identify a medium access control (MAC) layer frame to be transmitted during a transmission opportunity; determine that the MAC layer frame is a preemption frame; identify a preemptable frame to be transmitted during the transmission opportunity; cause to send the preemption frame during the transmission opportunity; and cause to send the preemptable frame after the transmission opportunity has concluded, wherein to cause to send the preemptable frame comprises to preempt transmission of the preemptable frame during the transmission opportunity based on the determination that the MAC layer frame is a preemption frame.

Example 2 may include the device of example 1 and/or some other example herein, wherein the preemption frame is a first preemption frame, and wherein the processing circuitry is further configured to: identify a second preemption frame to be transmitted during the transmission opportunity; and cause to send the second preemption frame during the transmission opportunity.

Example 3 may include the device of example 1 and/or some other example herein, wherein the processing circuitry is further configured to: cause storage of the preemptable frame in a first buffer; and cause storage of the preemption frame in a second buffer, wherein to determine that the MAC layer frame is a preemption frame comprises to determine that the second buffer comprises the MAC layer frame.

Example 4 may include the device of example 1 and/or some other example herein, wherein the processing circuitry is further configured to determine a transmission deadline associated with the MAC layer frame, wherein to determine that the MAC layer frame is a preemption frame is based on the transmission deadline.

Example 5 may include the device of example 1 and/or some other example herein, wherein the processing circuitry is further configured to determine an arrival deadline associated with the MAC layer frame, wherein to determine that the MAC layer frame is a preemption frame is based on the arrival deadline.

Example 6 may include the device of example 1 and/or some other example herein, wherein the device is an access point device, wherein the preemptable frame is a downlink frame, and wherein the processing circuitry is further configured to: cause to send a trigger frame associated with causing a station device to send a second preemptive frame to the access point device; and identify the second preemptive frame received from the station device before causing to send the preemptable frame.

Example 7 may include the device of example 1 and/or some other example herein, wherein to cause to send the preemptive frame comprises to cause to send an aggregated MAC frame comprising the preemptive frame and at least one additional frame.

Example 8 may include the device of example 1 and/or some other example herein, wherein the processing circuitry is further configured to: identify a second preemptable frame to be transmitted during the transmission opportunity; determine that a size of the second preemptable frame fails to exceed a size threshold; and cause to send, based on the determination that the size fails to exceed the size threshold, the second preemptable frame during the transmission opportunity before causing to send the preemptive frame.

Example 9 may include the device of example 1 and/or some other example herein, wherein the processing circuitry is further configured to determine that a size of the preemptable frame exceeds a size threshold, wherein to preempt the transmission of the preemptable frame is based on the determination that the size exceeds the size threshold.

Example 10 may include the device of example 1 and/or some other example herein, wherein the processing circuitry is further configured to: identify a second preemptable frame to be transmitted during the transmission opportunity; determine a guard interval time during the transmission opportunity and preceding the transmission of the preemptive frame; and cause to send the second preemptable frame during the transmission opportunity before the guard interval time.

Example 11 may include the device of example 1 and/or some other example herein, further comprising a transceiver configured to transmit and receive wireless signals, the wireless signals including the preemption frame and the preemptable frame.

Example 12 may include the device of example 11 and/or some other example herein, further comprising an antenna coupled to the transceiver to cause to send the wireless signals.

Example 13 may include a non-transitory computer-readable medium storing computer-executable instructions which when executed by one or more processors result in performing operations comprising: identifying a medium access control (MAC) layer frame to be transmitted during a transmission opportunity; determining that the MAC layer frame is a preemption frame; identifying a preemptable frame to be transmitted during the transmission opportunity; causing to send the preemption frame during the transmission opportunity; and causing to send the preemptable frame after the transmission opportunity has concluded, wherein causing to send the preemptable frame comprises preempting transmission of the preemptable frame during the transmission opportunity based on the determination that the MAC layer frame is a preemption frame.

Example 14 may include the non-transitory computer-readable medium of example 13 and/or some other example herein, wherein the preemption frame is a first preemption frame, the operations further comprising: identifying a second preemption frame to be transmitted during the transmission opportunity; and causing to send the second preemption frame during the transmission opportunity.

Example 15 may include the non-transitory computer-readable medium of example 13 and/or some other example herein, the operations further comprising: causing storage of the preemptable frame in a first buffer; and causing storage of the preemption frame in a second buffer, wherein determining that the MAC layer frame is a preemption frame comprises determining that the second buffer comprises the MAC layer frame.

Example 16 may include the non-transitory computer-readable medium of example 13 and/or some other example herein, the operations further comprising determining a transmission deadline associated with the MAC layer frame, wherein determining that the MAC layer frame is a preemption frame is based on the transmission deadline.

Example 17 may include a method comprising: identifying, by processing circuitry of a device, a medium access control (MAC) layer frame to be transmitted during a transmission opportunity; determining, by the processing circuitry, that the MAC layer frame is a preemption frame; identifying, by the processing circuitry, a preemptable frame to be transmitted during the transmission opportunity; causing to send, by the processing circuitry, the preemption frame during the transmission opportunity; and causing to send, by the processing circuitry, the preemptable frame after the transmission opportunity has concluded, wherein causing to send the preemptable frame comprises preempting transmission of the preemptable frame during the transmission opportunity based on the determination that the MAC layer frame is a preemption frame.

Example 18 may include the method of example 17 and/or some other example herein, wherein the preemption frame is a first preemption frame, the method further comprising: identifying a second preemption frame to be transmitted during the transmission opportunity; and causing to send the second preemption frame during the transmission opportunity.

Example 19 may include the method of example 17 and/or some other example herein, the method further comprising: causing storage of the preemptable frame in a first buffer; and causing storage of the preemption frame in a second buffer, wherein determining that the MAC layer frame is a preemption frame comprises determining that the second buffer comprises the MAC layer frame.

Example 20 may include the method of example 17 and/or some other example herein, the method further comprising determining a transmission deadline associated with the MAC layer frame, wherein determining that the MAC layer frame is a preemption frame is based on the transmission deadline.

Example 21 may include an apparatus comprising means for: identifying a medium access control (MAC) layer frame to be transmitted during a transmission opportunity; determining that the MAC layer frame is a preemption frame; identifying a preemptable frame to be transmitted during the transmission opportunity; causing to send the preemption frame during the transmission opportunity; and causing to send the preemptable frame after the transmission opportunity has concluded, wherein causing to send the preemptable frame comprises preempting transmission of the preemptable frame during the transmission opportunity based on the determination that the MAC layer frame is a preemption frame.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
identify a medium access control (MAC) layer frame to be transmitted during a transmission opportunity;
determine that the MAC layer frame is a preemption frame;
identify a preemptable frame to be transmitted during the transmission opportunity;
cause to send the preemption frame during the transmission opportunity; and
cause to send the preemptable frame after the transmission opportunity has concluded, wherein to cause to send the preemptable frame comprises to preempt transmission of the preemptable frame during the transmission opportunity based on the determination that the MAC layer frame is a preemption frame.

2. The device of claim 1, wherein the preemption frame is a first preemption frame, and wherein the processing circuitry is further configured to:
identify a second preemption frame to be transmitted during the transmission opportunity; and
cause to send the second preemption frame during the transmission opportunity.

3. The device of claim 1, wherein the processing circuitry is further configured to:
cause storage of the preemptable frame in a first buffer; and
cause storage of the preemption frame in a second buffer,
wherein to determine that the MAC layer frame is a preemption frame comprises to determine that the second buffer comprises the MAC layer frame.

4. The device of claim 1, wherein the processing circuitry is further configured to determine a transmission deadline associated with the MAC layer frame, wherein to determine that the MAC layer frame is a preemption frame is based on the transmission deadline.

5. The device of claim 1, wherein the processing circuitry is further configured to determine an arrival deadline associated with the MAC layer frame, wherein to determine that the MAC layer frame is a preemption frame is based on the arrival deadline.

6. The device of claim 1, wherein the device is an access point device, wherein the preemptable frame is a downlink frame, and wherein the processing circuitry is further configured to:
cause to send a trigger frame associated with causing a station device to send a second preemptive frame to the access point device; and
identify the second preemptive frame received from the station device before causing to send the preemptable frame.

7. The device of claim 1, wherein to cause to send the preemption frame comprises to cause to send an aggregated MAC frame comprising the preemption frame and at least one additional frame.

8. The device of claim 1, wherein the processing circuitry is further configured to:
identify a second preemptable frame to be transmitted during the transmission opportunity;
determine that a size of the second preemptable frame fails to exceed a size threshold; and
cause to send, based on the determination that the size fails to exceed the size threshold, the second preemptable frame during the transmission opportunity before causing to send the preemption frame.

9. The device of claim 1, wherein the processing circuitry is further configured to determine that a size of the preemptable frame exceeds a size threshold, wherein to preempt the transmission of the preemptable frame is based on the determination that the size exceeds the size threshold.

10. The device of claim 1, wherein the processing circuitry is further configured to:
identify a second preemptable frame to be transmitted during the transmission opportunity;
determine a guard interval time during the transmission opportunity and preceding the transmission of the preemption frame; and
cause to send the second preemptable frame during the transmission opportunity before the guard interval time.

11. The device of claim 1, further comprising a transceiver configured to transmit and receive wireless signals, the wireless signals including the preemption frame and the preemptable frame.

12. The device of claim 11, further comprising an antenna coupled to the transceiver to cause to send the wireless signals.

13. A non-transitory computer-readable medium storing computer-executable instructions which when executed by one or more processors result in performing operations comprising:
identifying a medium access control (MAC) layer frame to be transmitted during a transmission opportunity;
determining that the MAC layer frame is a preemption frame;
identifying a preemptable frame to be transmitted during the transmission opportunity;
causing to send the preemption frame during the transmission opportunity; and
causing to send the preemptable frame after the transmission opportunity has concluded, wherein causing to send the preemptable frame comprises preempting transmission of the preemptable frame during the transmission opportunity based on the determination that the MAC layer frame is a preemption frame.

14. The non-transitory computer-readable medium of claim 13, wherein the preemption frame is a first preemption frame, the operations further comprising:
identifying a second preemption frame to be transmitted during the transmission opportunity; and
causing to send the second preemption frame during the transmission opportunity.

15. The non-transitory computer-readable medium of claim 13, the operations further comprising:
causing storage of the preemptable frame in a first buffer; and
causing storage of the preemption frame in a second buffer,
wherein determining that the MAC layer frame is a preemption frame comprises determining that the second buffer comprises the MAC layer frame.

16. The non-transitory computer-readable medium of claim 13, the operations further comprising determining a transmission deadline associated with the MAC layer frame, wherein determining that the MAC layer frame is a preemption frame is based on the transmission deadline.

17. A method comprising:
identifying, by processing circuitry of a device, a medium access control (MAC) layer frame to be transmitted during a transmission opportunity;
determining, by the processing circuitry, that the MAC layer frame is a preemption frame;
identifying, by the processing circuitry, a preemptable frame to be transmitted during the transmission opportunity;
causing to send, by the processing circuitry, the preemption frame during the transmission opportunity; and
causing to send, by the processing circuitry, the preemptable frame after the transmission opportunity has concluded, wherein causing to send the preemptable frame comprises preempting transmission of the preemptable frame during the transmission opportunity based on the determination that the MAC layer frame is a preemption frame.

18. The method of claim 17, wherein the preemption frame is a first preemption frame, the method further comprising:
identifying a second preemption frame to be transmitted during the transmission opportunity; and
causing to send the second preemption frame during the transmission opportunity.

19. The method of claim 17, the method further comprising:
causing storage of the preemptable frame in a first buffer; and
causing storage of the preemption frame in a second buffer,
wherein determining that the MAC layer frame is a preemption frame comprises determining that the second buffer comprises the MAC layer frame.

20. The method of claim 17, the method further comprising determining a transmission deadline associated with the MAC layer frame, wherein determining that the MAC layer frame is a preemption frame is based on the transmission deadline.
